(19) United States
(12) Patent Application Publication
(10) Pub. No.: US 2022/0020084 A1
(43) Pub. Date: Jan. 20, 2022

(54) ACCOUNT ASSIGNMENT MANAGER FOR COLLECTION AND RECOVERY

(71) Applicant: FAIR ISAAC CORPORATION, Roseville, MN (US)

(72) Inventors: Xuezhi Zhang, Beijing (CN); Peng Zhou, Beijing (CN); Liupeng Wang, Beijing (CN)

(21) Appl. No.: 16/929,077

(22) Filed: Jul. 14, 2020

(51) Int. Cl. G06Q 40/02; G06Q 20/10; G06Q 20/08

(52) U.S. Cl. CPC G06Q 40/02; G06Q 20/0855; G06Q 20/102

(57) ABSTRACT

Computer-implemented methods and systems for account assignment, collection and recovery are provided. The method may include providing, in a graphical user interface, one or more options for selecting a plurality of accounts, the one or more options including a first graphical user interface feature that allows a user to provide or select at least one filtering criteria based on which a set of accounts from among the plurality of accounts is selected. A list of plurality of collection agencies may be provided such that a user may select one or more collection agencies from the list by interacting with a second graphical user interface feature.

### TECHNICAL FIELD

The disclosed subject matter generally relates to managing accounts in collection and, more particularly, to an improved system that provides an efficient configurable computing platform and filtering architecture for managing debtor accounts and assigning collection account.

### BACKGROUND

Many organizations including banks, utility companies, healthcare providers, and governmental agencies rely on collection agencies to manage and collect debt. Some organizations may utilize the services of multiple collection agencies for the purpose of achieving cost efficiency or to comply with certain regulations and internal policies and procedures.

For example, a collection agency may provide very cost-effective collection services in terms of fees charged. Naturally, an organization would want to hire the collection agency that offers the most competitive fees. However, a low-cost collection agency may not be able to effectively collect certain types of debts, or overall may be less effective than another collection agency that charges higher fees but has a better return on collections or success rate.

For an organization that is interested in collecting a higher return per collection account, it would be important to hire a collection agency or a plurality of collection agencies that can meet the organization's expected goals according to certain objectives. These objectives may be defined in terms of recovery speed, total recovery per account, and ultimately the costs associated with collection and recovery.

Currently available collection and recovery technologies are generally inefficient. For example, assigning certain debts or collection accounts to multiple collection agencies according to a defined distribution is difficult or rather impossible. Further, no customizable or configurable computer-implemented systems or methods are available that can address the above-noted shortcomings in the currently-implemented debt collection technologies by way of user friendly and functionally effective graphical interfaces.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with some implementations of the disclosed subject matter, computer-implemented methods and systems for account assignment for collection and recovery are provided. The method may include providing, in a graphical user interface, one or more options for selecting a plurality of accounts, the one or more options including a first graphical user interface feature that allows a user to provide or select at least one filtering criteria based on which a set of accounts from among the plurality of accounts is selected. A list of plurality of collection agencies may be provided such that a user may select one or more collection agencies from the list by interacting with a second graphical user interface feature.

In response to the user selecting the one or more collection agencies, a third graphical user interface feature may be provided that allows a user define a distribution of the selected plurality of accounts across the selected one or more collection agencies. The graphical user interface provides the user with an option to define one or more time periods associated with the selected one or more collection agencies. A first time period associated with a first collection agency indicates a first amount of time given to the first collection agency to collect a debt for at least a first account assigned to the first collection agency.

In some aspects, the first account is assigned to a second collection agency from among the selected one or more collection agencies after the first amount of time has lapsed. A second time period associated with the second collection agency indicates a second amount of time given to the second collection agency to collect the debt for the first account. A user interaction with the graphical user interface results in a report indicating one or more optimal assignment scenarios for distribution of the selected plurality of accounts across the selected one or more collection agencies. The plurality of accounts may include accounts that are delinquent past a threshold time period.

Depending on implementation, the selected plurality of accounts are evenly distributed among a plurality of selected collection agencies for collection purposes. The one or more time periods are implemented to promote a predetermined level of return from collection efforts by the one or more collection agencies. The predetermined level of return may be configurable to be above a threshold return rate.

Implementations of the current subject matter may include, without limitation, systems and methods consistent with the above methodology and processes, including one or more features and articles that comprise a tangibly embodied machine or computer-readable medium operable to cause one or more machines (e.g., computers, processors, etc.) to result in operations disclosed herein, by way of, for example, logic code or one or more computing programs that cause one or more processors to perform one or more of the disclosed operations or functionalities. The machines may exchange data, commands or other instructions via one or more connections, including but not limited to a connection over a network.

The details of one or more variations of the subject matter described herein are set forth in the accompanying drawings and the description below. Other features and advantages of the subject matter described herein will be apparent from the description and drawings, and from the claims. The disclosed subject matter is not, however, limited to any particular embodiment disclosed.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations as provided below.

FIG. 1 illustrates an example operating environment, in accordance with one or more embodiments, in which an improved computing platform and configurable architecture may be implemented.

FIG. 2 is an example graphical user interface configured to allow a user assign multiple accounts to multiple collection agencies based on configurable proportions or distributions, in accordance with one embodiment.

FIG. 3 is an example flow diagram of a method of assigning multiple accounts to multiple collection agencies according to a desirable distribution factor, in accordance with one embodiment.

FIG. 4 is a block diagram of an example computing system that may be utilized to perform one or more computing operations or processes as consistent with one or more disclosed features.

The figures may not be to scale in absolute or comparative terms and are intended to be exemplary. The relative placement of features and elements may have been modified for the purpose of illustrative clarity. Where practical, the same or similar reference numbers denote the same or similar or equivalent structures, features, aspects, or elements, in accordance with one or more embodiments.

### DETAILED DESCRIPTION OF EXAMPLE IMPLEMENTATIONS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

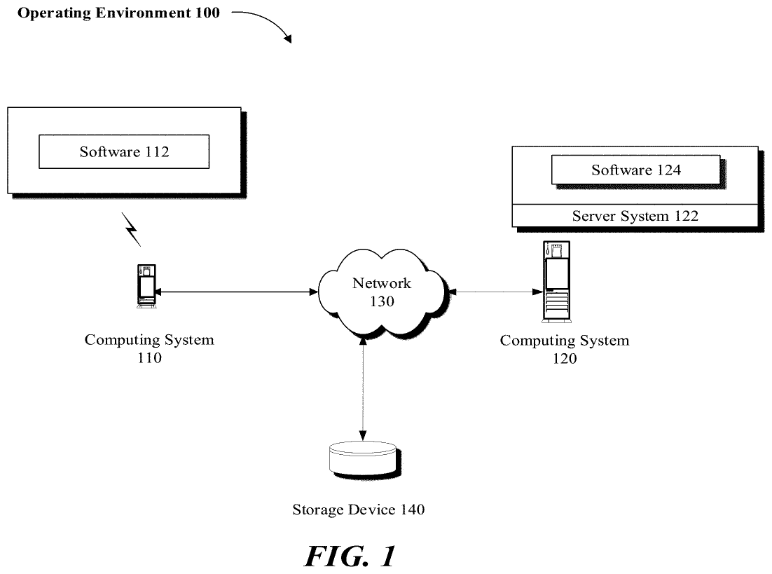

Referring to FIG. 1, an example operating environment 100 is illustrated in which a computing system 110 may be used by a user to interact with software 112 being executed on computing system 110. Software 112 may be implemented on a computing platform to allow a user assign multiple consumer collection accounts to various collection agencies. Software 112 advantageously provides novel and improved sorting and filtering mechanisms and features that allow a user selectively define configurable criteria, such that certain sets or subsets of collection accounts are chosen for the purpose of assignment to certain collection agencies. The assignment may be performed in a customizable fashion among one or more collection agencies and over predefined or user-definable time periods.

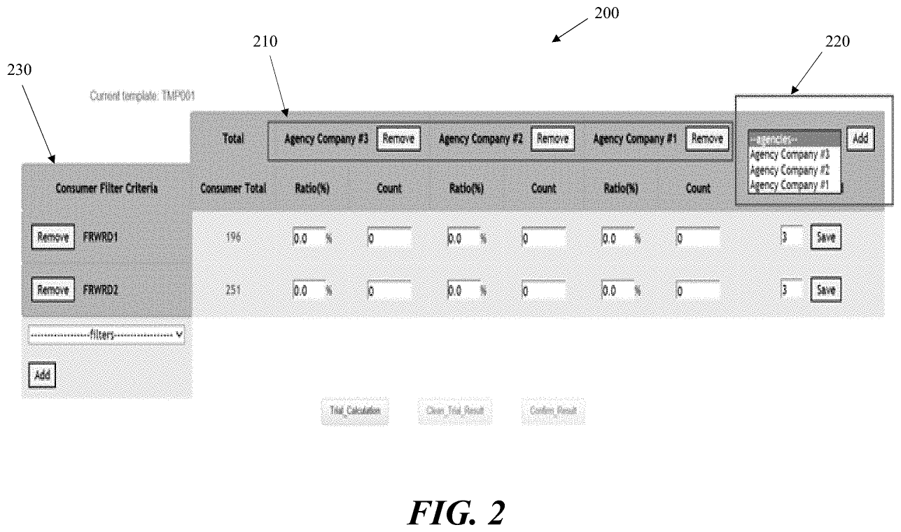

The computing system 110 may be a general-purpose computer, a handheld mobile device (e.g., a smart phone), a tablet, or other communication capable computing device. Software 112 may be a web browser, a dedicated app or other type of software application running either fully or partially on computing system 110. As provided in further detail with respect to FIG. 2, software 112 may cause a graphical user interface 200 to be rendered on a display. The graphical user interface 200 may include visual and functional aspects and features 210, 220 and 230 with which a user may interact to manipulate the operation of software 112.

Referring back to FIG. 1, computing system 110 may communicate over a network 130 to access data stored on storage device 140 or to access services provided by a computing system 120. Depending on implementation, storage device 140 may be local to, remote to, or embedded in one or more of computing systems 110 or 120. A server system 122 may be configured on computing system 120 to service one or more requests submitted by computing system 110 or software 112 (e.g., client systems) via network 130. Network 130 may be implemented over a local or wide area network (e.g., the Internet).

Computing system 120 and server system 122 may be implemented over a centralized or distributed (e.g., cloud-based) computing environment as dedicated resources, or may be configured as virtual machines that define shared processing or storage resources. Execution, implementation or instantiation of software 124, or the related features and components (e.g., software objects), over server system 122 may also define a special purpose machine that provides remotely situated client systems, such as computing system 110 or software 112, with access to a variety of data and services as provided below.

In accordance with one or more implementations, the provided services by the special purpose machine or software 124 may include providing a user, using computing system 110 or software 112, with the capability to forward or assign collection accounts based on specified ratios or distribution factors among a number of selected collection agencies. In one example embodiment, the assignment of the accounts may be according to a distribution that evenly assigns the collection accounts among the multiple collection agencies.

For example, the user may be able to use software 112 to assign an equal number of accounts among several selected collection agencies. In some embodiments, software 112 may be configured to assign the collection accounts based on account values. Software 112 may also include a trial or prediction feature to provide a projected report about the number or value of collection accounts being assigned. Depending on information available about the effectiveness of each collection agency, software 112 may also generate the expected collection outlook in terms of recovery speed, total recovery per account, and ultimately the costs associated with collection and recovery in different scenarios or according to different distributions.

In accordance with one aspect, software 112 may provide an automated calculation feature, which provides an assignment summary (and if desirable added details) prior to actual assignment of the collection accounts to selected agencies. The assignment summary may be used for preliminary decision-making purposes. For example, based on the summary, a user may advantageously update the selected agencies and distribution factors to recalculate expected outcomes and reconfigure any parameters prior to the actual assignment of accounts to the selected agencies.

As an illustrative example, the assignment summary may indicate or predict that according to a first assignment scenario, if the collection period is one year, 50% of the accounts will be successfully collected against with an average return of 30% per account. This result may be generated by software 112 according to known data available about the selected collection agencies and the respective success rates. The projections may be determined based on data collected and fed to a self-learning artificial intelligence (AI) machine that is capable of analyzing and classifying new input data in view of historic or training data.

The user may determine that the generated outcome under the first assignment scenario is not satisfactory, or may want to determine various possibilities according to different collection strategies. The user may update the collection parameters by interacting with configurable features of software 112 to, for example, select different agencies or a different distribution or time factors to generate a new assignment summary recalculated according to a second assignment scenario.

For example, under the first scenario, the user may have selected agencies A, B and C with an even distribution across a number of collection accounts (e.g., ⅓ across each of the three agencies). The user may set the time factor as giving each of the agencies one year to collect against the accounts assigned to them, without transferring any of the accounts to another agency during that time period.

Under a second scenario, the user may select agencies A, C and D, but assign 70% of the accounts to agency A, 20% of the accounts to agency C, and 10% of the accounts to agency D for a period of four months, and then forward or reallocate 25% of the uncollected accounts from agency A to agency C, and similarly 25% of uncollected accounts from agency C to agency D every four months thereafter for up to a maximum of two years from the time of original assignment.

Given the new distribution and time factors under the second scenario, software 112 may generate a new summary that predicts 70% of the accounts will be successfully collected against, with an average return of 50% per account over the course of the selected time period (e.g. two years). The summary may also include a predicted net rate of return per scenario based on the associated costs of collection per agency. For example, under the first scenario, the predicted net rate of return may be 40%, while under the second scenario, the predicted net rate of return may be 45%.

Given the parameters and predictions in the above example scenarios, the user may decide to choose the first assignment scenario, because it is easier to manage and faster, despite that hypothetically an extra 5% return may be possible, if the collection efforts are extended by an extra year and the accounts are sequentially moved or shuffled from one agency to the next. As provided in further detail herein, the user interface 200 and the functionality of software 112 provide improvements and advantages over the existing computer-implemented collection technologies by allowing the user to optimally configure the account assignment settings with a clear view of possible outcomes across different collection factors and scenarios.

Depending on implementation, software 112 in conjunction with the example systems and interfaces displayed in FIGS. 1 and 2 is configured to provide one or more features that allow customization over a secure, end-to-end computing and networking platform to promote and support collections and recovery management and help organizations collect and recover more debt, control costs, increase revenue, and stay compliant. The debt collection system may be used by a debt manager in a highly configurable manner for collections, recovery, debt sale, vendor management, bankruptcy, repossession, and asset remarketing.

Referring back to FIG. 2, in certain embodiments, a debt collection system may provide a user-friendly graphical user interface (GUI) 200 for flexible assignment of collection accounts, so that several or most features of the system are accessible from within one main screen. As shown, the features may be directed to selecting or removing one or more collection agencies (e.g., interfaces 210 and 220). Conditions for selecting a batch of consumers according to one or more user-selectable options (e.g., filter criteria 230) may be also provided. A user may specify the account distributions assigned to a particular agency, the assignment period, the projected results, and other details, desirably within a simple interactive consul or GUI platform.

In some aspects, an interactive screen such as that illustrated in exemplary FIG. 2 may be displayed to a user. Secure access and authentication may be implemented via Spring Security, or other Lightweight Directory Access Protocol (LDAP) integration. LDAP provides a lightweight client-server protocol for accessing directory services over TCP/IP or other connection-oriented transfer services and also provides for highly customizable authentication and access-control framework that focuses on both authentication and authorization in a seamless manner.

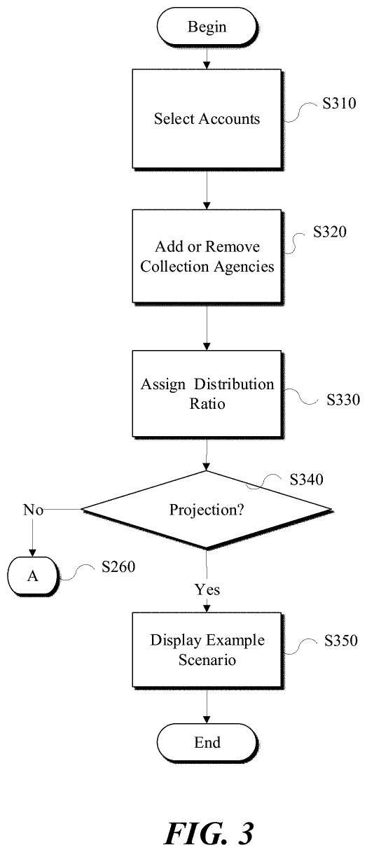

Referring to FIGS. 2 and 3, in accordance with one or more embodiments, a user may interact with GUI 200 features, such as filter criteria 230 selection mechanism (e.g., a dropdown menu, button, text field, or other structural or functional equivalents) to choose or define the conditions for selecting a batch of collection accounts (S310). The conditions may be defined using one or more data filters or queries that help select a set or subset of accounts from a collection system or database. Users may interact with filter criteria 230 to add or remove desirable conditions or criteria.

In some implementations, GUI 200 may include interactive features 210 and 220 that allow a user to add or remove one or more collection agencies (S320). The addition or removal of a collection agency may be performed by, for example, selecting from an agency list 220 or selecting a GUI button. As the result of the user interaction, available agencies may be loaded from a database that includes a list of suitable collection agencies and desirable the various characteristics (e.g., success rate, costs, etc.) associated with said agencies. A list of the loaded agencies may be displayed in a drop-down list 220, in response to user interaction.

Once one or more collection agencies are added to GUI 200, the user may continue to interact with GUI 200 to include one or more values into one or more data fields, such as those shown in FIG. 2, in order to assign distribution ratios and optionally collection periods for the one or more collection agencies (S330). The distribution ratios may define the share of consumer accounts assigned to the different agencies for collection. The collection periods may define the length of time a collection agency has the assignment before the collection account is either dropped or transferred to another collection agency.

In some embodiments, after the user has selected the collection accounts and the attributes associated with the timing and distribution of the accounts across one or more chosen collection agencies, the user may be given an option to generate one or more projections about the results that may be achieved, if the selected agencies are employed to collect against the accounts (S340). The user may thus interact with GUI 200 to cause software 112 generate results that display one or more example scenarios (S350). These example scenarios may include collection details that are predicted by an AI classification model to give the user some understanding of the possible collection outcomes.

In other words, software 112 is configured to allow the user select the collection agencies and the terms of collection as related to the number of accounts per agency and the length of time a selected agency is allowed to initiate and maintain collection efforts. The AI model is trained and utilized to provide a projection about, for example, the success rate of collection by the various collection agencies and other important details associated with the collection process, such as the cost of collection, the total consumer count, individual or total balance per consumer, and distribution of accounts among the selected agencies.

The details generated may be based on conditions selected by the user and criteria used to assign the accounts to an agency. As provided in the earlier example scenarios, depending on the results generated and the projections, a user may decide to use a particular group of collection agencies to collect one or more accounts, according to distribution ratios or collection periods that are most optimal or complementary to the collection objectives and strategies of a user or an organization.

The AI model may be developed and trained based on intelligent algorithms and according to industry experience, or based on customer requirements and preferences. Such preferences may include the length of time given to a collection agency to collect the debt, the manner in which the debt is collected and which other collection agency to be selected, if the currently assigned agency is not fully successful in collecting the outstanding balance for an account. In some aspect, the accounts may be distributed among a plurality of collection agencies evenly based on the outstanding balance.

A user may be provided with the option to update and customize the input into the various fields in GUI 200 numerous times, until the user is satisfied that the selected distributions and time periods for the collection exercise meet the user's requirements and goals. The generated results may be stored as a digital file and the values inputted into the GUI 200 may be stored in a data matrix for future retrieval and use. In one example configuration, the user may opt to select a collection scenario that minimizes the number of times the collection of debt is assigned to a new agency, while maximizing the return on collection. In certain implementations, the system may automatically suggest one or more options to the user that match user defined expectations.

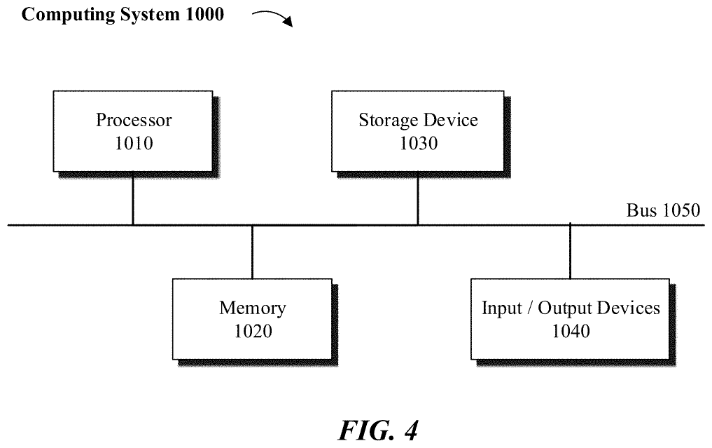

Referring to FIG. 4, a block diagram illustrating a computing system 1000 consistent with one or more embodiments is provided. The computing system 1000 may be used to implement or support one or more platforms, infrastructures or computing devices or computing components that may be utilized, in example embodiments, to instantiate, implement, execute or embody the methodologies disclosed herein in a computing environment using, for example, one or more processors or controllers, as provided below.

As shown in FIG. 4, the computing system 1000 can include a processor 1010, a memory 1020, a storage device 1030, and input/output devices 1040. The processor 1010, the memory 1020, the storage device 1030, and the input/output devices 1040 can be interconnected via a system bus 1050. The processor 1010 is capable of processing instructions for execution within the computing system 1000. Such executed instructions can implement one or more components of, for example, a cloud platform. In some implementations of the current subject matter, the processor 1010 can be a single-threaded processor. Alternately, the processor 1010 can be a multi-threaded processor. The processor 1010 is capable of processing instructions stored in the memory 1020 and/or on the storage device 1030 to display graphical information for a user interface provided via the input/output device 1040.

The memory 1020 is a computer readable medium such as volatile or non-volatile that stores information within the computing system 1000. The memory 1020 can store data structures representing configuration object databases, for example. The storage device 1030 is capable of providing persistent storage for the computing system 1000. The storage device 1030 can be a floppy disk device, a hard disk device, an optical disk device, or a tape device, or other suitable persistent storage means. The input/output device 1040 provides input/output operations for the computing system 1000. In some implementations of the current subject matter, the input/output device 1040 includes a keyboard and/or pointing device. In various implementations, the input/output device 1040 includes a display unit for displaying graphical user interfaces.

According to some implementations of the current subject matter, the input/output device 1040 can provide input/output operations for a network device. For example, the input/output device 1040 can include Ethernet ports or other networking ports to communicate with one or more wired and/or wireless networks (e.g., a local area network (LAN), a wide area network (WAN), the Internet).

In some implementations of the current subject matter, the computing system 1000 can be used to execute various interactive computer software applications that can be used for organization, analysis and/or storage of data in various (e.g., tabular) format (e.g., Microsoft Excel®, and/or any other type of software). Alternatively, the computing system 1000 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 1040. The user interface can be generated and presented to a user by the computing system 1000 (e.g., on a computer screen monitor, etc.).

One or more aspects or features of the subject matter disclosed or claimed herein may be realized in digital electronic circuitry, integrated circuitry, specially designed application specific integrated circuits (ASICs), field programmable gate arrays (FPGAs) computer hardware, firmware, software, and/or combinations thereof. These various aspects or features may include implementation in one or more computer programs that may be executable and/or interpretable on a programmable system including at least one programmable processor, which may be special or general purpose, coupled to receive data and instructions from, and to transmit data and instructions to, a storage system, at least one input device, and at least one output device. The programmable system or computing system may include clients and servers. A client and server may be remote from each other and may interact through a communication network. The relationship of client and server arises by virtue of computer programs running on the respective computers and having a client-server relationship to each other.

These computer programs, which may also be referred to as programs, software, software applications, applications, components, or code, may include machine instructions for a programmable controller, processor, microprocessor or other computing or computerized architecture, and may be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium may store such machine instructions non-transitorily, such as for example as would a non-transient solid-state memory or a magnetic hard drive or any equivalent storage medium. The machine-readable medium may alternatively or additionally store such machine instructions in a transient manner, such as for example as would a processor cache or other random access memory associated with one or more physical processor cores.

To provide for interaction with a user, one or more aspects or features of the subject matter described herein may be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices may be used to provide for interaction with a user as well. For example, feedback provided to the user may be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

### Terminology

When a feature or element is herein referred to as being “on” another feature or element, it may be directly on the other feature or element or intervening features and/or elements may also be present. In contrast, when a feature or element is referred to as being “directly on” another feature or element, there may be no intervening features or elements present. It will also be understood that, when a feature or element is referred to as being “connected”, “attached” or “coupled” to another feature or element, it may be directly connected, attached or coupled to the other feature or element or intervening features or elements may be present. In contrast, when a feature or element is referred to as being “directly connected”, “directly attached” or “directly coupled” to another feature or element, there may be no intervening features or elements present.

Although described or shown with respect to one embodiment, the features and elements so described or shown may apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments and implementations only and is not intended to be limiting. For example, as used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, steps, operations, processes, functions, elements, and/or components, but do not preclude the presence or addition of one or more other features, steps, operations, processes, functions, elements, components, and/or groups thereof. As used herein, the term “and/or” includes any and all combinations of one or more of the associated listed items and may be abbreviated as “/”.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms, such as “forward”, “rearward”, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features due to the inverted state. Thus, the term “under” may encompass both an orientation of over and under, depending on the point of reference or orientation. The device may be otherwise oriented (rotated 90 degrees or at other orientations) and the spatially relative descriptors used herein interpreted accordingly. Similarly, the terms “upwardly”, “downwardly”, “vertical”, “horizontal” and the like may be used herein for the purpose of explanation only unless specifically indicated otherwise.

Although the terms “first” and “second” may be used herein to describe various features/elements (including steps or processes), these features/elements should not be limited by these terms as an indication of the order of the features/elements or whether one is primary or more important than the other, unless the context indicates otherwise. These terms may be used to distinguish one feature/element from another feature/element. Thus, a first feature/element discussed could be termed a second feature/element, and similarly, a second feature/element discussed below could be termed a first feature/element without departing from the teachings provided herein.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise.

For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, may represent endpoints or starting points, and ranges for any combination of the data points. For example, if a particular data point “10” and a particular data point “15” may be disclosed, it is understood that greater than, greater than or equal to, less than, less than or equal to, and equal to 10 and 15 may be considered disclosed as well as between 10 and 15. It is also understood that each unit between two particular units may be also disclosed. For example, if 10 and 15 may be disclosed, then 11, 12, 13, and 14 may be also disclosed.

Although various illustrative embodiments have been disclosed, any of a number of changes may be made to various embodiments without departing from the teachings herein. For example, the order in which various described method steps are performed may be changed or reconfigured in different or alternative embodiments, and in other embodiments one or more method steps may be skipped altogether. Optional or desirable features of various device and system embodiments may be included in some embodiments and not in others. Therefore, the foregoing description is provided primarily for the purpose of example and should not be interpreted to limit the scope of the claims and specific embodiments or particular details or features disclosed.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal.

The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

The examples and illustrations included herein show, by way of illustration and not of limitation, specific embodiments in which the disclosed subject matter may be practiced. As mentioned, other embodiments may be utilized and derived therefrom, such that structural and logical substitutions and changes may be made without departing from the scope of this disclosure. Such embodiments of the disclosed subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve an intended, practical or disclosed purpose, whether explicitly stated or implied, may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The disclosed subject matter has been provided here with reference to one or more features or embodiments. Those skilled in the art will recognize and appreciate that, despite of the detailed nature of the example embodiments provided here, changes and modifications may be applied to said embodiments without limiting or departing from the generally intended scope. These and various other adaptations and combinations of the embodiments provided here are within the scope of the disclosed subject matter as defined by the disclosed elements and features and their full set of equivalents.

A portion of the disclosure of this patent document may contain material, which is subject to copyright protection. The owner has no objection to facsimile reproduction by any one of the patent documents or the patent disclosure, as it appears in the Patent and Trademark Office patent files or records, but reserves all copyrights whatsoever. Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

What is claimed is:

1. A computer-implemented method comprising:
providing, in a graphical user interface, one or more options for selecting a plurality of accounts, the one or more options including a first graphical user interface feature that allows a user to provide or select at least one filtering criteria based on which a set of accounts from among the plurality of accounts is selected;
providing a list of plurality of collection agencies such that a user may select one or more collection agencies from the list by interacting with a second graphical user interface feature; and
in response to the user selecting the one or more collection agencies, providing a third graphical user interface feature that allows a user define a distribution of the selected plurality of accounts across the selected one or more collection agencies.

2. The method of claim 1, wherein the graphical user interface provides the user with an option to define one or more time periods associated with the selected one or more collection agencies.

3. The method of claim 2, wherein a first time period associated with a first collection agency indicates a first amount of time given to the first collection agency to collect a debt for at least a first account assigned to the first collection agency.

4. The method of claim 3, wherein the first account is assigned to a second collection agency from among the selected one or more collection agencies after the first amount of time has lapsed.

5. The method of claim 4, wherein a second time period associated with the second collection agency indicates a second amount of time given to the second collection agency to collect the debt for the first account.

6. The method of claim 5, wherein user interaction with the graphical user interface results in a report indicating one or more optimal assignment scenarios for distribution of the selected plurality of accounts across the selected one or more collection agencies.

7. The method of claim 1, wherein the plurality of accounts include accounts that are delinquent past a threshold time period.

8. The method of claim 2, wherein the selected plurality of accounts are evenly distributed among a plurality of selected collection agencies for collection purposes.

9. The method of claim 2, wherein the one or more time periods are implemented to promote a predetermined level of return from collection efforts by the one or more collection agencies.

10. The method of claim 9, wherein the predetermined level of return is configurable to be above a threshold return rate.

11. A system comprising:
at least one programmable processor; and
a non-transitory machine-readable medium storing instructions that, when executed by the at least one programmable processor, cause the at least one programmable processor to perform operations comprising:
providing, in a graphical user interface, one or more options for selecting a plurality of accounts, the one or more options including a first graphical user interface feature that allows a user to provide or select at least one filtering criteria based on which a set of accounts from among the plurality of accounts is selected;
providing a list of plurality of collection agencies such that a user may select one or more collection agencies from the list by interacting with a second graphical user interface feature; and
in response to the user selecting the one or more collection agencies, providing a third graphical user interface feature that allows a user define a distribution of the selected plurality of accounts across the selected one or more collection agencies.

12. The system of claim 11, wherein the graphical user interface provides the user with an option to define one or more time periods associated with the selected one or more collection agencies.

13. The system of claim 12, wherein a first time period associated with a first collection agency indicates a first amount of time given to the first collection agency to collect a debt for at least a first account assigned to the first collection agency.

14. The system of claim 13, wherein the first account is assigned to a second collection agency from among the selected one or more collection agencies after the first amount of time has lapsed.

15. The system of claim 14, wherein a second time period associated with the second collection agency indicates a second amount of time given to the second collection agency to collect the debt for the first account.

16. A computer program product comprising a non-transitory machine-readable medium storing instructions that, when executed by at least one programmable processor, cause the at least one programmable processor to perform operations comprising:
providing, in a graphical user interface, one or more options for selecting a plurality of accounts, the one or more options including a first graphical user interface feature that allows a user to provide or select at least one filtering criteria based on which a set of accounts from among the plurality of accounts is selected;
providing a list of plurality of collection agencies such that a user may select one or more collection agencies from the list by interacting with a second graphical user interface feature; and
in response to the user selecting the one or more collection agencies, providing a third graphical user interface feature that allows a user define a distribution of the selected plurality of accounts across the selected one or more collection agencies.

17. The computer program product of claim 16, wherein the graphical user interface provides the user with an option to define one or more time periods associated with the selected one or more collection agencies.

18. The computer program product of claim 17, wherein a first time period associated with a first collection agency indicates a first amount of time given to the first collection agency to collect a debt for at least a first account assigned to the first collection agency.

19. The computer program product of claim 18, wherein the first account is assigned to a second collection agency from among the selected one or more collection agencies after the first amount of time has lapsed.

20. The computer program product of claim 19, wherein a second time period associated with the second collection agency indicates a second amount of time given to the second collection agency to collect the debt for the first account.
